(19) United States
(12) Patent Application Publication
(10) Pub. No.: US 2022/0338263 A1
(43) Pub. Date: Oct. 20, 2022

(54) FAILED RECEIVING OF TIMING ADVANCE (TA) COMMAND FOR RADIO RESOURCE CONTROL (RRC) CONNECTED USER EQUIPMENT (UE) IN TWO-STEP RANDOM ACCESS PROCEDURE

(71) Applicant: QUALCOMM Incorporated, San Diego, CA (US)

(72) Inventors: Ruiming ZHENG, Beijing (CN); Linhai HE, San Diego, CA (US); Ozcan OZTURK, San Diego, CA (US); Jing LEI, San Diego, CA (US); Gavin Bernard HORN, La Jolla, CA (US)

(21) Appl. No.: 17/634,530

(22) PCT Filed: Aug. 13, 2020
(86) PCT No.: PCT/US2020/046228

§ 371 Date: Feb. 10, 2022

(30) Foreign Application Priority Data
Aug. 13, 2019 (CN) PCT/CN2019/100353

(51) Int. Cl. H04W 74/08; H04L 1/18

(52) U.S. Cl. CPC H04W 74/0833; H04L 1/1812

(57) ABSTRACT

Wireless communication devices, systems, and methods related to handling user equipment's (UE's) failure to receive a timing advance (TA) command from a base station during in a two-step random access procedure are provided. For example, a method of wireless communication can include transmitting a first random access channel (RACH) message (e.g., msgA); monitoring for a second RACH message (e.g., msgB) from the BS including a timing advance (TA) command; performing a hybrid automatic repeat request (HARQ) procedure on the second RACH message; and performing, when the HARQ procedure on the second RACH message fails, at least one of: starting a new RACH procedure or triggering a radio link failure (RLF).

### CROSS-REFERENCE TO RELATED APPLICATIONS

The present application is a 35 U.S.C. 371 National Phase entry of Patent Cooperation Treaty (PCT) Application No. PCT/US2020/046228, filed Aug. 13, 2020, which claims priority to and the benefit of Patent Cooperation Treaty (PCT) Application No. PCT/CN2019/100353, filed Aug. 13, 2019, which are hereby incorporated by reference in their entireties as if fully set forth below and for all applicable purposes.

### TECHNICAL FIELD

This application relates to wireless communication systems, and more particularly to methods (and associated devices and systems) for handling a radio resource control (RRC) connected user equipment's (UE's) failure to receive a timing advance (TA) command from a base station during in a two-step random access procedure.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

A UE may synchronize to a network for initial cell access by performing a random access procedure, which may include the exchange of a number of messages (e.g., 4 in some instances) between the UE and a BS. There is a latency in establishing the initial connection with the network. After synchronizing with the BS through the initial random access procedure, the UE attaches to the network via a radio resource control (RRC) connection with the BS. The RRC-connected UE may still initiate/perform a random access procedure by exchanging a number of messages (e.g., 2 in some instances) with the BS. The initiation of the random access procedure may be due to various reasons, for example, when the UE detects an out-of-synchronization condition with the BS. Further, the UE may move from one cell coverage area to another cell coverage area. When the UE moves out of a current serving cell coverage area, a handover process may be performed to enable the UE to continue communication with the network in a different cell coverage area. Thus, there is a need to handle random access procedures in a manner that is efficient and reduces latency in synchronizing to the network in order to provide improved user experiences.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication includes transmitting, by user equipment (UE) to a base station (BS), a first random access channel (RACH) message; monitoring, by the UE, for a second RACH message from the BS, the second RACH message including a timing advance (TA) command, performing, by the UE, a hybrid automatic repeat request (HARQ) procedure on the second RACH message; and performing, by the UE when the HARQ procedure on the second RACH message fails, at least one of: starting a new RACH procedure; or triggering a radio link failure (RLF).

In an additional aspect of the disclosure, a method of wireless communication includes monitoring, by a base station (BS) with a user equipment (UE), for a first random access channel (RACH) message from the UE; transmitting, by the BS to the UE, a second RACH message in response to receiving the first RACH message, the second RACH message including a timing advance (TA) command; performing, by the BS, a hybrid automatic repeat request (HARQ) procedure on the second RACH message; and terminating, by the BS, a current RACH procedure for the UE when the HARQ procedure on the second RACH message fails.

In an additional aspect of the disclosure, a user equipment (UE) includes a transceiver configured to: transmit a first random access channel (RACH) message to the BS; and monitor for a second RACH message from the BS, the second RACH message including a timing advance (TA) command; and a processor in communication with the transceiver, the processor configured to: perform a hybrid automatic repeat request (HARQ) procedure on the second RACH message; and perform, when the HARQ procedure on the second RACH message fails, at least one of: start a new RACH procedure or trigger a radio link failure (RLF).

In an additional aspect of the disclosure, a base station includes a transceiver configured to: monitor for a first random access channel (RACH) message from the UE and transmit a second RACH message to the UE in response to receiving the first RACH message, the second RACH message including a timing advance (TA) command; and a processor in communication with the transceiver, the processor configured to perform a hybrid automatic repeat request (HARQ) procedure on the second RACH message and terminate a current RACH procedure for the UE when the HARQ procedure on the second RACH message fails.

In an additional aspect of the disclosure, a non-transitory computer-readable medium has program code recorded thereon, the program code including code for causing a user equipment (UE) to transmit a first random access channel (RACH) message to a base station (BS); code for causing the UE to monitor for a second RACH message from the BS, the second RACH message including a timing advance (TA) command; code for causing the UE to perform a hybrid automatic repeat request (HARQ) procedure on the second RACH message; and code for causing the UE to perform, when the HARQ procedure on the second RACH message fails, at least one of: starting a new RACH procedure or triggering a radio link failure (RLF).

In an additional aspect of the disclosure, a non-transitory computer-readable medium has program code recorded thereon, the program code including code for causing a base station (BS) to monitor for a first random access channel (RACH) message from a user equipment (UE); code for causing the BS to transmit a second RACH message to the UE in response to receiving the first RACH message, the second RACH message including a timing advance (TA) command; code for causing the BS to perform a hybrid automatic repeat request (HARQ) procedure on the second RACH message, and code for causing the BS to terminate a current RACH procedure for the UE when the HARQ procedure on the second RACH message fails.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 illustrates a wireless communication network according to some embodiments of the present disclosure.

FIG. 2 illustrates a protocol diagram of a wireless communication method according to some embodiments of the present disclosure.

FIG. 3 illustrates a flow diagram of a wireless communication method according to some embodiments of the present disclosure.

FIG. 4 is a block diagram of a user equipment (UE) according to some embodiments of the present disclosure.

FIG. 5 is a block diagram of an exemplary base station (BS) according to embodiments of the present disclosure.

FIG. 6A illustrates a message structure according to some embodiments of the present disclosure.

FIG. 6B illustrates a message structure according to some embodiments of the present disclosure.

FIG. 7 illustrates a scheduling/transmission configuration according to some embodiments of the present disclosure.

FIG. 8 illustrates a flow diagram of a wireless communication method according to some embodiments of the present disclosure.

FIG. 9 illustrates a flow diagram of a wireless communication method according to some embodiments of the present disclosure.

FIG. 10 illustrates a flow diagram of a wireless communication method according to some embodiments of the present disclosure.

FIG. 11 illustrates a flow diagram of a wireless communication method according to some embodiments of the present disclosure.

FIG. 12 illustrates a flow diagram of a wireless communication method according to some embodiments of the present disclosure.

FIG. 13 illustrates a flow diagram of a wireless communication method according to embodiments of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks. LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11. IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification, 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ˜1M nodes/km²), ultra-low complexity (e.g., ˜10s of bits/sec), ultra-low energy (e.g., ˜10+ years of battery life), and deep coverage with the capability to reach challenging locations: (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries, 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In a wireless communication network, a radio resource control (RRC) connected UE may perform a random access procedure. The random access procedure may include transmitting a RACH message (e.g., msgA) to a base station (BS) that includes a C-RNTI for the RRC-connected UE. After transmitting the RACH message, the UE monitors for a RACH reply message (e.g., msgB) from the BS. The RACH reply message can include a timing advance command (TAC) media access control (MAC) control element (CE). The UE can utilize the TAC MAC CE to synchronize its timing with the network. The UE utilizes a PDCCH addressed to the C-RNTI used by the RRC-connected UE in its RACH message (e.g., msgA) to identify and decode the RACH reply message (e.g., msgB) from the BS over the PDSCH. If the RRC-connected UE successfully decodes the RACH reply message (e.g., msgB) and acquires the TAC MAC CE, the UE synchronizes with the network and the RACH procedure is successful.

However, if the RRC-connected UE does not receive the PDCCH addressed to the C-RNTI, successfully receive and decode the RACH reply message (e.g., msgB), and/or acquire the TAC MAC CE, in accordance with the present disclosure the actions of a UE are specified in order to resolve the outcome of the random access procedure in an efficient manner. To this end, aspects of the present disclosure include performing a hybrid automatic repeat request (HARQ) procedure on the RACH reply message (msgB) and, if the HARQ procedure fails, starting a new RACH procedure and/or triggering a radio link failure (RLF). These and other aspects of the present disclosure can provide several benefits. For example, the disclosed embodiments can reduce the amount of time and resources used by a RRC-connected UE in performing random access procedures. In this regard, the use of HARQ for msgB of a 2-step RACH procedure can reduce the latency required for the UE to synchronize with the network and avoid the need for an additional transmission of msgA by the UE. Further, the resolution of failed random access procedures can be expedited for the RRC-connected UE, including in some instances triggering a radio link failure (RLF) upon failure of the random access procedure. Additionally, HARQ resources can be released by providing a termination condition (e.g., timer and/or counter). Also, the RRC-connected UE can exit from the HARQ loop and retry another preamble (e.g., msgA) to expedite completion of a successful random access procedure. Additional features and benefits of the present disclosure are set forth in the following description.

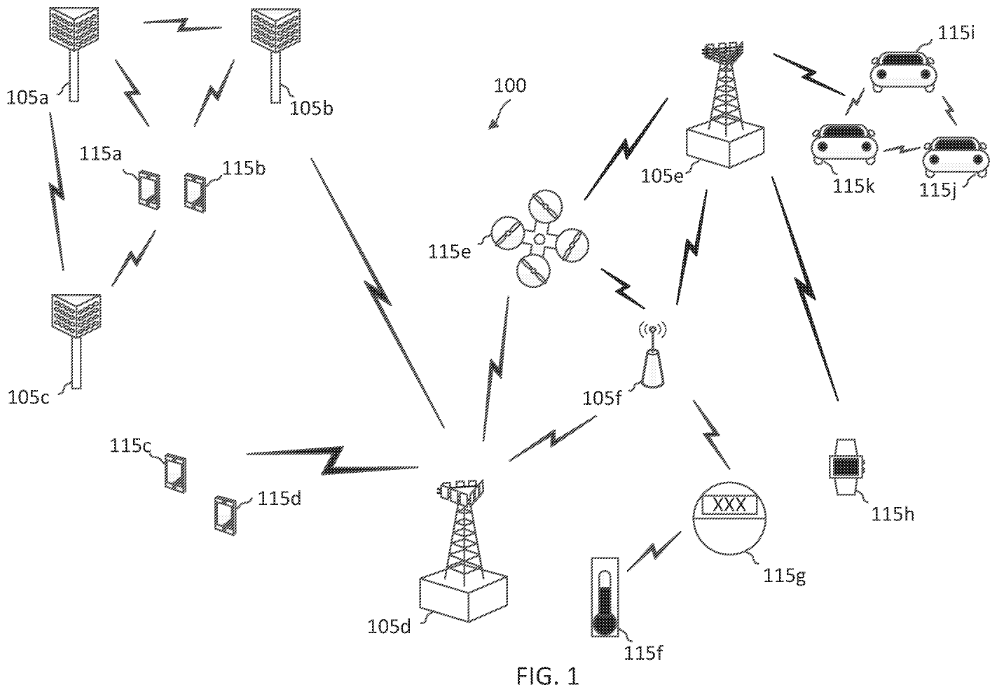

FIG. 1 illustrates a wireless communication network 100 according to some embodiments of the present disclosure. The network 100 may be a 5G network. The network 100 includes a number of base stations (BSs) 105 (individually labeled as 105a. 105b, 105c, 105d. 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115k are examples of various machines configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink and/or uplink, or desired transmission between BSs, and backhaul transmissions between BSs.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as in a vehicle-to-vehicle (V2V)

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In an embodiment, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some embodiments, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In an embodiment, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In an embodiment, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical laver identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as a message 1 (MSG 1), a message 2 (MSG 2), a message 3 (MSG 3), and a message 4 (MSG 4), respectively. In some examples, the random access procedure may be a two-step random access procedure, where the UE 115 may transmit a random access preamble and a connection request in a single transmission and the BS 105 may respond by transmitting a random access response and a connection response in a single transmission. For example, when the UE 115 has already attached to the network and has a radio resource control (RRC) connection with the BS 105, the UE may utilize the two-step random access procedure. The combined random access preamble and connection request in the two-step random access procedure may be referred to as a message A (MSG A). The combined random access response and connection response in the two-step random access procedure may be referred to as a message B (MSG B).

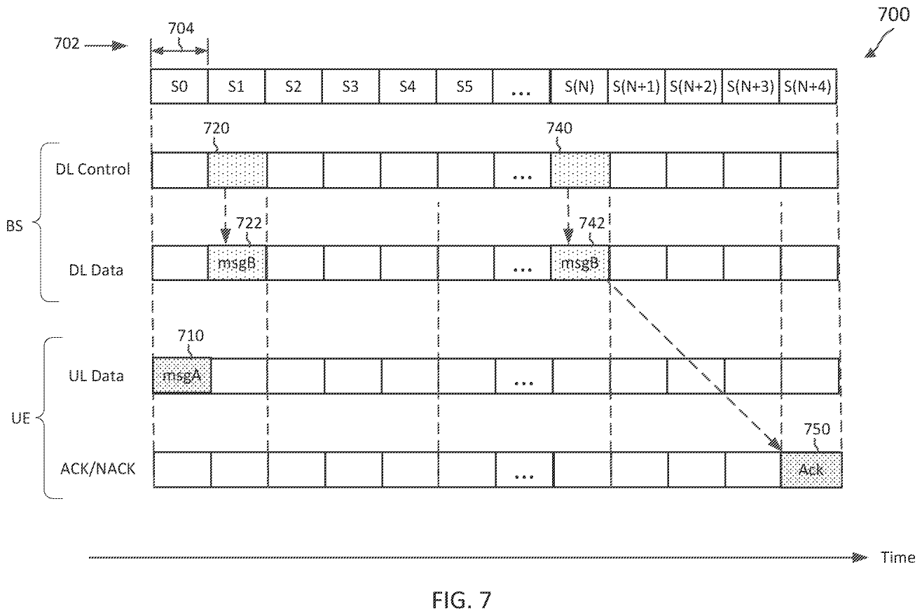

After establishing a connection, the UE 115 and the BS 105 can enter an operational state, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant. In some embodiments, the BS 105 and the UE 115 may employ hybrid automatic request (HARQ) techniques for communications to improve reliability as described in greater detail herein below. For example, a HARQ technique is utilized in the context of a two-step random access procedure between an RRC-connected UE and a BS in accordance with aspects of the present disclosure. FIG. 7 illustrates an exemplary HARQ technique suitable for use with the present disclosure.

The network 100 may operate over a shared frequency band or an unlicensed frequency band, for example, at about 3.5 gigahertz (GHz), sub-6 GHz or higher frequencies in the mmWave band. The network 100 may partition a frequency band into multiple channels, for example, each occupying about 20 megahertz (MHz). The BSs 105 and the UEs 115 may be operated by multiple network operating entities sharing resources in the shared communication medium and may acquire channel occupancy time (COT) in the share medium for communications. A COT may be non-continuous in time and may refer to an amount of time a wireless node can send frames when it has won contention for the wireless medium. Each COT may include a plurality of transmission slots. A COT may also be referred to as a transmission opportunity (TXOP).

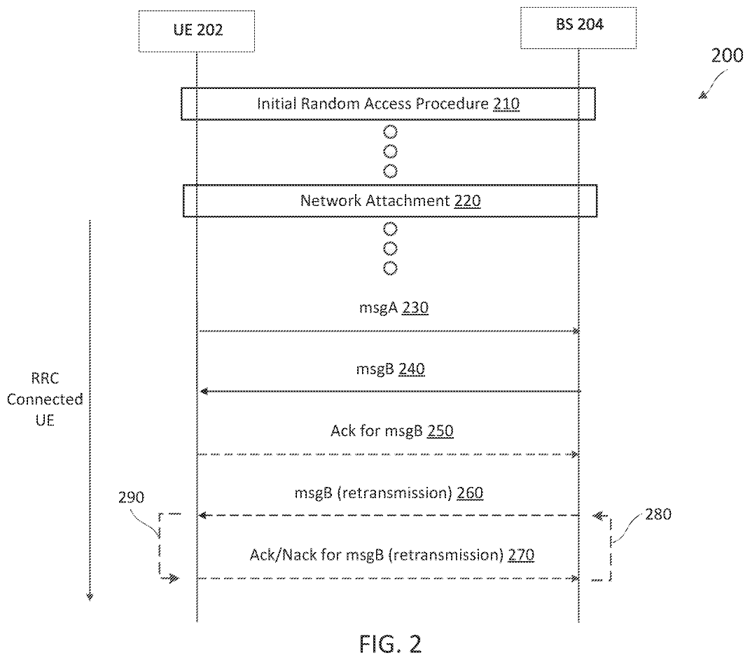

FIG. 2 illustrates a protocol diagram of a wireless communication method 200 between a UE 202 and a BS 204 according to some embodiments of the present disclosure. An initial random access procedure 210 is performed. The initial random access procedure 210 may occur when the UE 202 is first connecting to the network, is reconnecting to the network from idle mode, is handing over from one BS to another BS, or other suitable time. The initial random access procedure 210 may include a four-step random access procedure. For example, the UE 202 may transmit a random access preamble and the BS 204 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 202 may transmit a connection request to the BS 204 and the BS 204 may respond with a connection response. The connection response may indicate a contention resolution. In some examples, the random access preamble, the RAR, the connection request, and the connection response can be referred to as a message 1 (MSG 1), a message 2 (MSG 2), a message 3 (MSG 3), and a message 4 (MSG 4), respectively. The initial random access procedure 210 may include a two-step random access procedure, where the UE 202 transmits a random access preamble and a connection request in a single transmission and the BS 204 may respond by transmitting a random access response and a connection response in a single transmission. In the two-step random access procedure, the combined random access preamble and connection request may be referred to as a message A (MSG A), while the combined random access response and connection response may be referred to as a message B (MSG B). Following the initial random access procedure 210, the UE 202 is attached to the network via BS 204 as indicated by network attachment 220. Upon network attachment 220, the UE 202 has a radio resource control (RRC) connection with the BS 204 and, therefore, may be referred to as an RRC-connected UE (as shown on the left side of the protocol diagram of FIG. 2). Aspects of the present disclosure are related to the operations of RRC-connected UEs. For example, the present disclosure describes techniques for RRC-connected UEs to use in performing random access procedures, including techniques for handling the failure of an attempted random access procedure by a RRC-connected UE.

As shown in FIG. 2, the RRC-connected UE 202 can transmit msgA 230, including a C-RNTI assigned to the UE 202, to the BS 204. In response, the BS 204 can transmit msgB 240, including a timing advance (TA) command, to the UE 202. In this regard, the BS 204 can indicate over a PDCCH what resources of the PDSCH will be used to transmit msgB to the UE 202. For example, the BS 204 can include the C-RNTI utilized by the UE 202 in msgA in the PDCCH message (e.g., in a DL scheduling grant) indicating which PDSCH resources will be used. The UE 202 recognizes the C-RNTI in the PDCCH and utilizes the indicated PDSCH resources to receive and decode msgB from the BS 204. The UE 202 may transmit an ACK 250 to the BS 204 indicating the UE 202 was able to successfully receive and decode msgB, including the TA command. If the UE 202 successfully receives and decodes msgB and the TA command, then the UE 202 transmits the ACK 250 to the BS 204 and the random access procedure of the RRC-connected UE is complete. On the other hand, if the UE 202 fails to successfully receive and decode msgB, then the UE 202 may not respond to the BS (e.g., the ACK 250 is not transmitted to the BS). In response to not receiving the ACK 250 associated with msgB 240, the BS retransmits msgB 260 to the UE. The UE 202 may transmit an ACK 270 to the BS 204 indicating the UE 202 was able to successfully receive and decode the retransmission msgB or not respond to the BS 204 (e.g., not transmit the ACK 270) if the UE 202 fails to successfully receive and decode msgB. This process continues in a loop, as indicated by arrows 280 and 290, until (1) the UE successfully receives and decodes msgB at which point the random access procedure of the RRC-connected UE is successful or (2) a timer expires or a counter reaches a threshold at which point the random access procedure of the RRC-connected UE is considered to have failed.

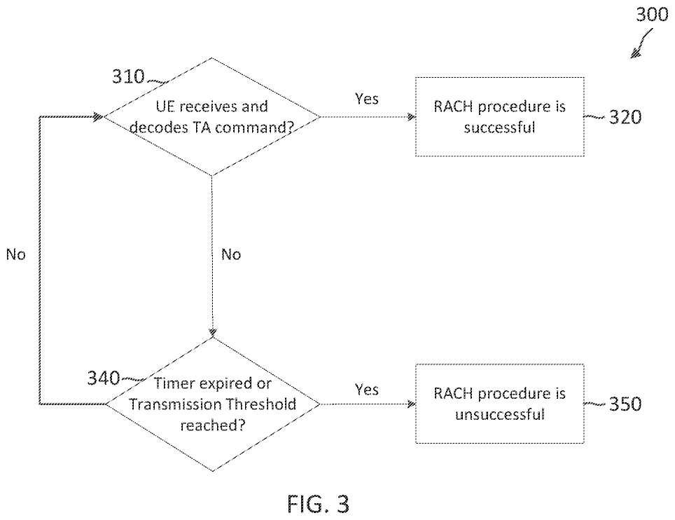

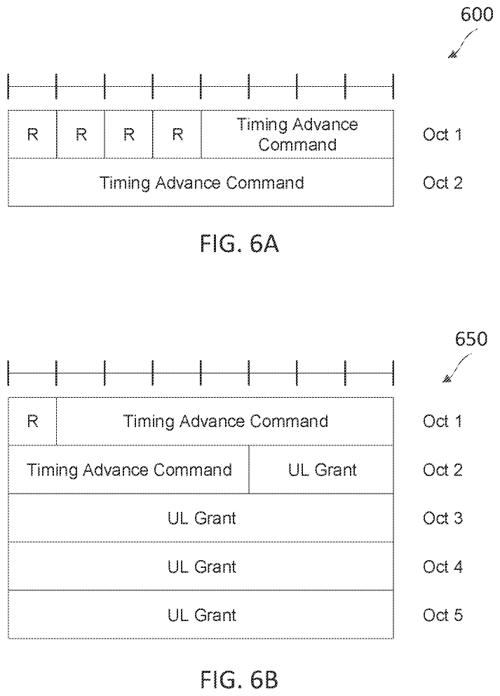

FIG. 3 illustrates a flow diagram of a wireless communication method 300 according to some embodiments of the present disclosure. In particular, the wireless communication method 300 shows aspects related to wireless communication method 200 described above. At step 310, it is determined whether the UE has received and successfully decoded a timing advance (TA) command (e.g., as included in msgB or another RACH message from the BS). In some instances, the TA command is a 12-bit TA command. For example, the TA command may have a format as shown in FIGS. 6A and 6B. If the UE successfully received and decoded the TA command, then the method 300 goes to step 320 and the random access procedure is successful and complete. Step 320 may include the UE transmitting an ACK to the BS indicating the successful receipt and decoding of the TA command. Step 320 may also include the UE canceling or stopping a timer and/or resetting a transmission counter associated with the random access procedure.

If at step 310, the UE failed to successfully receive and decode the TA command, then the method 300 goes to step 340 where the UE determines whether a timer has expired, or a transmission counter has reached a threshold. For example, the UE and/or the BS may implement a timer for limiting the amount of time spent attempting to complete a random access procedure. Similarly, the UE and/or the BS may implement a transmission counter limiting the number of times the BS will transmit/retransmit the TA command to the UE in attempting to complete a random access procedure. If the timer has not expired and/or the transmission counter has not reached its threshold, then the method 300 returns to step 310 where it is determined whether the UE has received and successfully decoded the TA command (e.g., from a retransmission from the BS). However, if the timer has expired and/or the transmission counter has reached its threshold, then the method 300 goes to step 350 and the random access procedure is considered to have failed. Aspects of the present disclosure specify the actions to be taken by a UE in order to resolve a failed random access procedure in an efficient manner, which can include triggering a radio link failure (RLF) and/or restarting the random access procedure (e.g., retransmitting msgA).

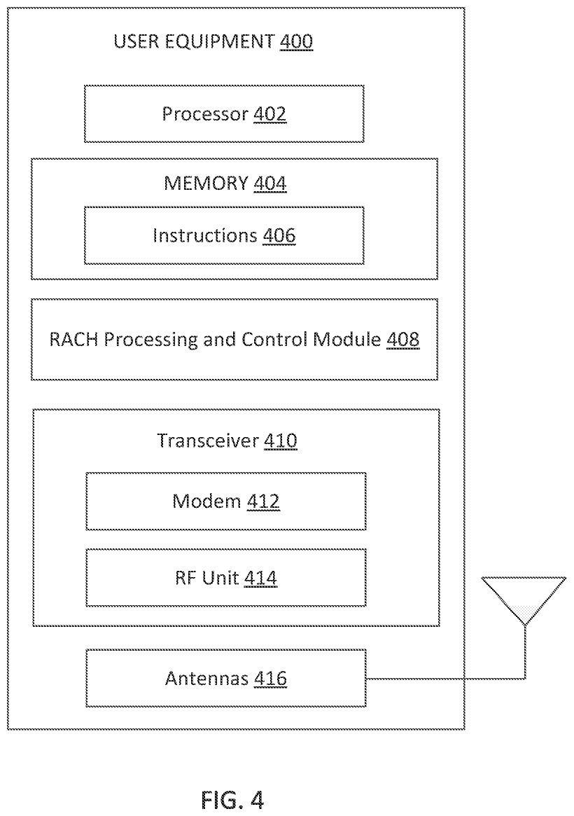

FIG. 4 is a block diagram of an exemplary UE 400 according to embodiments of the present disclosure. The UE 400 may be a UE 115 or UE 202 discussed above in FIGS. 1 and 2. As shown, the UE 400 may include a processor 402, a memory 404, a RACH processing and control module 408, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs 115 in connection with embodiments of the present disclosure, for example, aspects of FIGS. 2, 3, 6A-9, and 12. Instructions 406 may also be referred to as program code. The program code may be for causing a wireless communication device (or specific component(s) of the wireless communication device) to perform these operations, for example by causing one or more processors (such as processor 402) to control or command the wireless communication device (or specific component(s) of the wireless communication device) to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The RACH processing and control module 408 may be implemented via hardware, software, or combinations thereof. For example, RACH processing and control module 408 may be implemented as a processor, circuit, and/or instructions 406 stored in the memory 404 and executed by the processor 402. In some examples, the RACH processing and control module 408 can be integrated within the modem subsystem 412. For example, the RACH processing and control module 408 can be implemented by a combination of software components (e.g., executed by a DSP or a general processor) and hardware components (e.g., logic gates and circuitry) within the modem subsystem 412.

The RACH processing and control module 408 may be used for various aspects of the present disclosure, for example, aspects of FIGS. 2, 3, 6A-9, and 12. The RACH processing and control module 408 is configured to communicate with other components of the UE 400 to transmit of one or more RACH messages (e.g., msgA), receive one or more RACH messages (e.g., msgB), perform HARQ processing on one or more RACH messages (e.g., msgB), transmit an ACK/NACK for one or more RACH messages (e.g., msgB), determine whether a timer has expired, start a timer, cancel a timer, stop a timer, determine whether a transmission counter has reached a threshold, reset a transmission counter, restart a random access procedure, trigger RLF, and/or perform other functionalities related to the RACH procedures of a UE described in the present disclosure.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404, and/or the RACH processing and control module 408 according to a modulation and coding scheme (MCS) (e.g., a low-density panty check (LDPC) coding scheme, a turbo coding scheme, a convolutional coding scheme, a digital beamforming scheme, etc.). The RF unit 414 may be configured to process (e.g., perform analog to digital conversion or digital to analog conversion, etc.) modulated/encoded data (e.g., UL data bursts, RRC messages, RACH message(s) (e.g., msg A), ACK/NACKs for DL data bursts) from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 115 to enable the UE 115 to communicate with other devices.

The RF unit 414 may provide the modulated and/or processed data (e.g., data packets or, more generally, data messages that may contain one or more data packets and other information) to the antennas 416 for transmission to one or more other devices. The antennas 416 may further receive data messages transmitted from other devices. The antennas 416 may provide the received data messages for processing and/or demodulation at the transceiver 410. The transceiver 410 may provide the demodulated and decoded data (e.g., RACH message(s) (e.g., msgB), DL/UL scheduling grants, DL data bursts, RACH messages, RRC messages, ACK/NACK requests) to the RACH processing and control module 408 for processing. The antennas 416 may include multiple antennas of similar or different designs in order to sustain multiple transmission links. The RF unit 414 may configure the antennas 416.

In an embodiment, the UE 400 can include multiple transceivers 410 implementing different RATs (e.g., NR and LTE). In an embodiment, the UE 400 can include a single transceiver 410 implementing multiple RATs (e.g., NR and LTE). In an embodiment, the transceiver 410 can include various components, where different combinations of components can implement different RATs.

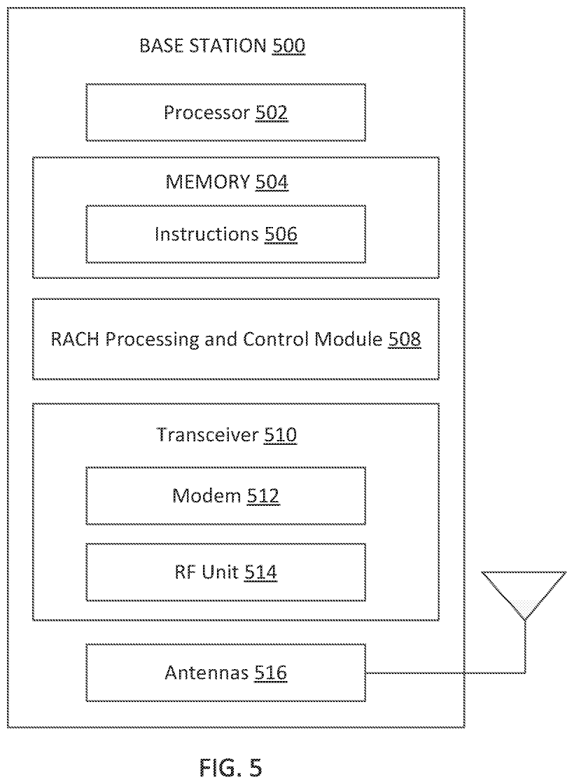

FIG. 5 is a block diagram of an exemplary BS 500 according to embodiments of the present disclosure. The BS 500 may be a BS 105 or BS 204 as discussed above in FIGS. 1 and 2. As shown, the BS 500 may include a processor 502, a memory 504, a RACH processing and control module 508, a transceiver 510 including a modem subsystem 512 and a RF unit 514, and one or more antennas 516. These elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some embodiments, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 2, 3, 6A-7, 10, 11, and 13. Instructions 506 may also be referred to as code, which may be interpreted broadly to include any type of computer-readable statement(s) as discussed above with respect to FIG. 4.

The RACH processing and control module 508 may be implemented via hardware, software, or combinations thereof. For example, the RACH processing and control module 508 may be implemented as a processor, circuit, and/or instructions 506 stored in the memory 504 and executed by the processor 502. In some examples, the RACH processing and control module 508 can be integrated within the modem subsystem 512. For example, the RACH processing and control module 508 can be implemented by a combination of software components (e.g., executed by a DSP or a general processor) and hardware components (e.g., logic gates and circuitry) within the modem subsystem 512.

The RACH processing and control module 508 may be used for various aspects of the present disclosure, for example, aspects of FIGS. 2, 3, 6A-7, 10, 11, and 13. The RACH processing and control module 508 is configured to transmit or retransmit one or more RACH messages having a timing advance (TA) command to a UE (e.g., the UEs 115 and/or 400), receive an ACK/NACK for one or more of the transmitted or retransmitted RACH messages, transmit one or more DL scheduling grants to a UE indicating DL resources (e.g., time-frequency resources), transmit DL data to the UE, transmit one or more UL scheduling grants to the UE indicating UL resources, receive UL data from the UE, etc.

The RACH processing and control module 508 is configured to is configured to communicate with other components of the BS 500 to receive of one or more RACH messages (e.g., msgA), transmit one or more RACH messages (e.g., msgB), perform HARQ processing on one or more RACH messages (e.g., msgB), receive an ACK/NACK for one or more RACH messages (e.g., msgB), determine whether a timer has expired, start a timer, cancel a timer, determine whether a transmission counter has reached a threshold, reset a transmission counter, terminate a random access procedure, and/or perform other functionalities related to the RACH procedures of a BS described in the present disclosure.

As shown, the transceiver 510 may include the modem subsystem 512 and the RF unit 514. The transceiver 510 can be configured to communicate bi-directionally with other devices, such as the UEs 115 and/or 400 and/or another core network element. The modem subsystem 512 may be configured to modulate and/or encode data according to a MCS (e.g., a LDPC coding scheme, a turbo coding scheme, a convolutional coding scheme, a digital beamforming scheme, etc.). The RF unit 514 may be configured to process (e.g., perform analog to digital conversion or digital to analog conversion, etc.) modulated/encoded data (e.g., RACH messages (e.g., msgB, etc.), ACK/NACK requests, DL/UL scheduling grants, DL data, RRC messages, etc.) from the modem subsystem 512 (on outbound transmissions) or of transmissions originating from another source, such as a UE 115 or 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, (e.g., data packets or, more generally, data messages that may contain one or more data packets and other information) to the antennas 516 for transmission to one or more other devices. This may include, for example, transmission of information to complete attachment to a network and communication with a camped UE 115 or 400 according to embodiments of the present disclosure. The antennas 516 may further receive data messages transmitted from other devices and provide the received data messages for processing and/or demodulation at the transceiver 510. The transceiver 510 may provide the demodulated and decoded data (e.g., RACH message(s) (e.g., msgA), ACK/NACKs for RACH message(s) (e.g., ACK/NACK for msgB), UL data, ACK/NACKs for DL data, etc.) to the RACH processing and control module 508 for processing. The antennas 516 may include multiple antennas of similar or different designs in order to sustain multiple transmission links.

In an embodiment, the BS 500 can include multiple transceivers 510 implementing different RATs (e.g., NR and LTE). In an embodiment, the BS 500 can include a single transceiver 510 implementing multiple RATs (e.g., NR and LTE). In an embodiment, the transceiver 510 can include various components, where different combinations of components can implement different RATs.

FIGS. 6A and 6B illustrate message structure formats for a timing advance (TA) command (e.g., as included in msgB or other RACH message from the BS) in accordance with the present disclosure. As shown in FIG. 6A, the TA command is a 12-bit TA command. The 12-bits of the TA command can be sent over two bytes (or octets). In the illustrated embodiment of FIG. 6A, four bits of the TA command are included with four reserved bits in one byte and eight bits of the TA command are in a second byte. However, the 12-bits of the TA command may be arranged in any suitable manner. FIG. 6B illustrates an embodiment where seven bits of the TA command are included with one reserved bit in one byte and five bits of the TA command are included with three bits of an UL grant in a second byte. In some implementations, the UL grant included with the TA command provides an indication of the UL resources to be used for transmitting an ACK related to the TA command. For example, the UL grant included with the TA command may be utilized to transmit an ACK related to the HARQ processing of a message carrying the TA command. While the illustrated message structure formats in FIGS. 6A and 6B include 12-bit TA commands, the present disclosure is applicable to any size and/or format of TA command.

FIG. 7 illustrates a scheduling/transmission configuration 700 according to some embodiments of the present disclosure. In particular, the scheduling/transmission configuration 200 illustrates a HARQ implementation for a RACH message according to some embodiments of the present disclosure. The transmission/scheduling configuration 700 may utilized in a HARQ communication of a RACH message (e.g., msgB) between a BS (e.g., BS 105, BS 204, and/or BS 500) and a UE (e.g., UE 115, UE 202, and/or UE 400). In FIG. 7, a frame structure 702 including a plurality of slots 704 in time in shown with the x-axis representing time in some constant units. The slots 704 are indexed from S0 to S9 for a radio frame and S(N) to S(N+4) may be for another radio frame. For example, a BS may communicate with a UE in units of slots 704. The slots 704 may also be referred to as transmission time intervals (TTIs). Each slot 704 or TTI carries a medium access control (MAC) layer transport block. Each slot 704 may include a number of symbols in time and a number of frequency tones in frequency. Each slot 704 may include a DL control portion followed by at least one of a subsequent DL data portion, UL data portion, and/or a UL control portion. In the context of LTE, 5G, or NR, the DL control portion, the DL data portion, the UL data portion, and the UL control portion may be referred to as a physical downlink control channel (PDCCH), a physical downlink shared channel (PDSCH), a physical uplink shared channel (PUSCH), and a physical uplink control channel (PUCCH), respectively.

The pattern-filled boxes represent transmissions of control information, data, and/or an ACK/NACK in corresponding slots 704. While an entire slot 704 may be shown as pattern-filled, a transmission may occur in only a portion of the slot 704. In FIG. 7, the pattern-filled boxes illustrate an exchange of RACH messages between a UE and BS, including HARQ processing for the RACH message transmitted from the BS to UE. As shown, in slot S0 the UE transmits a RACH message 710 (e.g., msgA) to the BS via an uplink channel (e.g., PRACH, PUSCH, PUCCH, etc.). The RACH message 710 includes a C-RNTI associated with the UE. In response, in slot S1 the BS transmits via a downlink control channel (e.g., PDCCH) a RACH control message 720 that includes the C-RNTI received in the RACH message 710. The RACH control message 720 indicates the time and frequency resources that will be utilized by the BS to transmit an associated RACH message 722 (e.g., msgB) to the UE. The RACH message 722 can include a TA command. The UE utilizes the assigned time and frequency resources to attempt to receive and decode the RACH message 722. In the illustrated example, the RACH message 722 is transmitted in slot S1 over a downlink channel (e.g., PDSCH).

After receiving the RACH message 722, the UE may report a reception status of the RACH message 224 to the BS. For example, the UE may transmit a feedback signal (or refrain from transmitting a feedback signal) to indicate to the BS whether the RACH message 224 was successfully received and/or decoded. For example, the feedback signal may include an acknowledgement (ACK) indicating that reception and decoding of the RACH message 722, including the TA command, by the UE is successful. Or the UE may not transmit a feedback signal to the BS to indicate that reception and decoding of the RACH message 722 and/or the TA command was unsuccessful (e.g., including an error or failing an error correction). The feedback signal may be associated with a certain HARQ process. The BS may indicate an feedback resource (e.g., a UCI resource) for the UE to transmit the ACK signal. For example, the BS may indicate the ACK resource in the RACH control message 720 and/or the RACH message 722. In some particular implementations, the BS indicates the ACK resource using the UL grant included with the TA command (e.g., using the message structure of FIG. 6B). In some instances, the UE does not respond to the BS with a feedback message unless the RACH message 722 is successfully received and decoded. That is, in some instances the UE may not transmit a feedback signal including a NACK to the BS when the RACH message 722 is not successfully received and/or decoded.

If the BS does not receive an ACK from the UE, then the BS may retransmit the RACH message 722, including the TA command, to the UE. For example, in the illustrated example of FIG. 7 the UE does not transmit an ACK related to RACH message 722 transmitted in slot S1 and, therefore, the BS retransmits the RACH message 722. In the illustrated example, the retransmission of the RACH message 722 is shown by the RACH control message 740 and RACH message 742 transmitted in slot S(N). Using a HARQ process, the BS may transmit various coded versions of the RACH message (e.g., RACH message 722, RACH message 742) to the UE. For example, the BS may transmit RACH message 722 as a first coded version of information (e.g., a TA command) and transmit RACH message 742 as a second coded version of the same information. The UE may combine the received first coded version and the received second coded version for error correction when both the received first coded version and the received second coded version are erroneous. This process can be repeated and used for any number of retransmissions (e.g., 4, 5, 6, 8, 10, 12, 15, 16, 20, etc.) of the information. In some implementations, the number of retransmissions of the RACH message from the BS to the UE is limited by at least one of a timer and/or a threshold number of transmissions. In some particular implementations, the BS provides an indicator in the RACH control message 720/740 (e.g., downlink assignment index (DAI) or similar index indicator) and/or in the RACH message 722/742 of the transmission number associated with that particular transmission. The UE can utilize the received indicator to determine whether a threshold number of transmissions has been reached. If the threshold number of transmissions has not been reached, then the UE can monitor for a retransmission. However, if the threshold number of transmissions has been reached, then the UE will know that the BS will not retransmit the RACH message and can proceed accordingly (e.g., by triggering RLF or retransmitting msgA). In an example, the UE may trigger the RLF by sending a RLF report to an upper layer (e.g., a MAC layer and/or a network layer) of the UE and the upper layer may trigger a radio link recovery procedure. When the UE is able to successfully receive and decode the RACH message from the BS (after any number of transmissions by the BS), the UE will transmit an ACK to the BS. In the illustrated embodiment, the UE is able to successfully receive and decode the RACH message (e.g., msgB) from the BS after receipt of RACH messages 722 and 742 and, therefore, transmits an ACK in slot S(n+4). It should be noted that the latency between each message transmission (e.g., the RACH messages 710, 720, 722, 740, 742 and/or ACK signal 750) may vary depending on the embodiments.

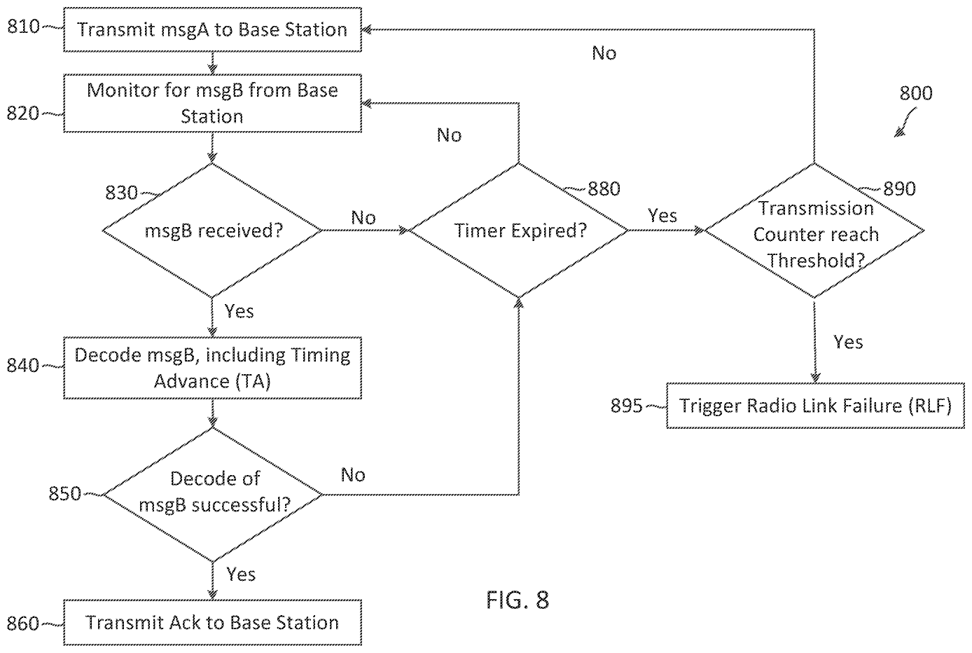

FIG. 8 illustrates a flow diagram of a wireless communication method 800 according to some embodiments of the present disclosure. Aspects of the method 800 can be executed by a wireless communication device, such as the UEs 115, 202, and/or 400 utilizing one or more components, such as the processor 402, the memory 404, the RACH communication and processing module 408, the transceiver 410, the modem 412, the one or more antennas 416, and various combinations thereof. As illustrated, the method 800 includes a number of enumerated steps, but embodiments of the method 800 may include additional steps before, after, and in between the enumerated steps. For example, in some instances one or more aspects of methods 200, 300, 900, and/or 1200, message structures 600 and/or 650, and/or scheduling/transmission configuration 700 may be implemented as part of method 800. Further, in some embodiments, one or more of the enumerated steps may be omitted or performed in a different order.

At step 810, an RRC-connected UE transmits a RACH message (e.g., msgA) to a BS. The RACH message includes an identifier (e.g., C-RNTI) associated with the RRC-connected UE.

At step 820, the RRC-connected UE monitors for a RACH response message (e.g., msgB) from the BS. In this regard, the RRC-connected UE can monitor time and frequency resources (e.g., time/frequency resources of a PDSCH) assigned to the RRC-connected UE for the RACH response message. For example, in some instances the BS communicates the assigned time and frequency resources to the RRC-connected UE over a control channel (e.g., PDCCH). The BS can include the identifier (e.g., C-RNTI) received from the RRC-connected UE in the RACH message transmitted at step 810 in the control channel message to indicate to the RRC-connected UE which time and frequency resources are associated with the RACH response message (e.g., msgB) intended for the RRC-connected UE.

At step 830, the RRC-connected UE determines whether the RACH response message (e.g., msgB) has been received. If yes, then the method 800 proceeds to step 840 where the RRC-connected UE decodes the RACH response message, including a timing advance (TA) command of the RACH response message.

At step 850, the RRC-connected UE determines whether the decode of the RACH response message, including the TA command, was successful. If yes, then the method 800 proceeds to step 860 where the RRC-connected UE transmits an ACK to the BS indicating that the random access procedure was successful (e.g., the RRC-connected UE is synchronized with the network). In some instances, at step 860 the RRC-connected cancels the timer associated with step 880 and/or resets the counter associated with step 890.

If, at step 850, the RRC-connected UE determines that the decode of the RACH response message, including the TA command, was unsuccessful, then the method 800 proceeds to step 880. Also, if, at step 830, the RRC-connected UE determines the RACH response message (e.g., msgB) is not received, then the method 800 proceeds to step 880. At step 880, the RRC-connected UE determines whether a timer has expired. The timer can define the amount of time the RRC-connected UE will spend attempting to receive and/or decode the RACH response message (e.g., msgB) from the BS. In some instances, the timer is started upon starting or finishing the transmission of the RACH message (e.g., msgA) by the RRC-connected UE in step 810. The timer can be set for any suitable length of time, including without limitation between 10 ms and 500 ms, between 10 ms and 100 ms, 10 ms, 20 ms, 32 ms, 40 ms, 50 ms, 64 ms, 100 ms, 150 ms, 200 ms, 500 ms, etc. The RRC-connected UE may include one or more other timers (e.g., a contention resolution timer) associated with random access procedures in addition to the timer of step 880.

If, at step 880, the RRC-connected UE determines that the timer has not expired, then the method 800 continues to step 820. At step 820, the RRC-connected UE monitors for a retransmission of the RACH response message (e.g., msgB) from the BS. In this regard, the retransmission may take the form of HARQ process for the RACH response message. As discussed above, FIG. 7 describes an approach for a HARQ process suitable for the RACH response message (e.g., signals 720 and 722 are associated with the first transmission, while signals 740 and 742 are associated with a retransmission). From step 820, the method 800 continues to step 830 and proceeds as described above.

If, at step 880, the RRC-connected UE determines that the timer has expired, then the method 800 continues to step 890. At step 890, the RRC-connected UE determines whether a transmission counter threshold has been reached. The transmission counter can define the number of times the RRC-connected UE will transmit the RACH message (e.g., msgA) to the BS in a given time period. In some instances, the transmission counter is incremented each time the RRC-connected UE transmits the RACH message (e.g., msgA) at step 810. The transmission counter can be reset when the RRC-connected UE successfully completes the random access procedure (e.g., step 860) or triggers a radio link failure (RLF) (e.g., step 895). The threshold or limit for the transmission counter can be set for any suitable number of transmissions, including without limitation between 2 and 100, between 2 and 20, between 2 and 10, 2, 4, 8, 16, 32, 64, etc. The RRC-connected UE may include one or more other counters (e.g., a msgB counter) associated with random access procedures in addition to the transmission counter of step 890.

If, at step 890, the RRC-connected UE determines that the transmission counter threshold has not been reached, then the method 800 continues to step 810. At step 810, the RRC-connected UE retransmits of the RACH message (e.g., msgA) to the BS and the method 800 proceeds as described above.

If, at step 890, the RRC-connected UE determines that the transmission counter threshold has been reached, then the method 800 continues to step 895. At step 895, the RRC-connected UE triggers a RLF. In some instances, step 890 is omitted such that the method 800 proceeds directly to step 895 from step 880 if RRC-connected UE determines that the timer at step 880 has expired. Similarly, if the method 800 can proceed to step 810 from step 880 if RRC-connected UE determines that the timer at step 880 has not expired

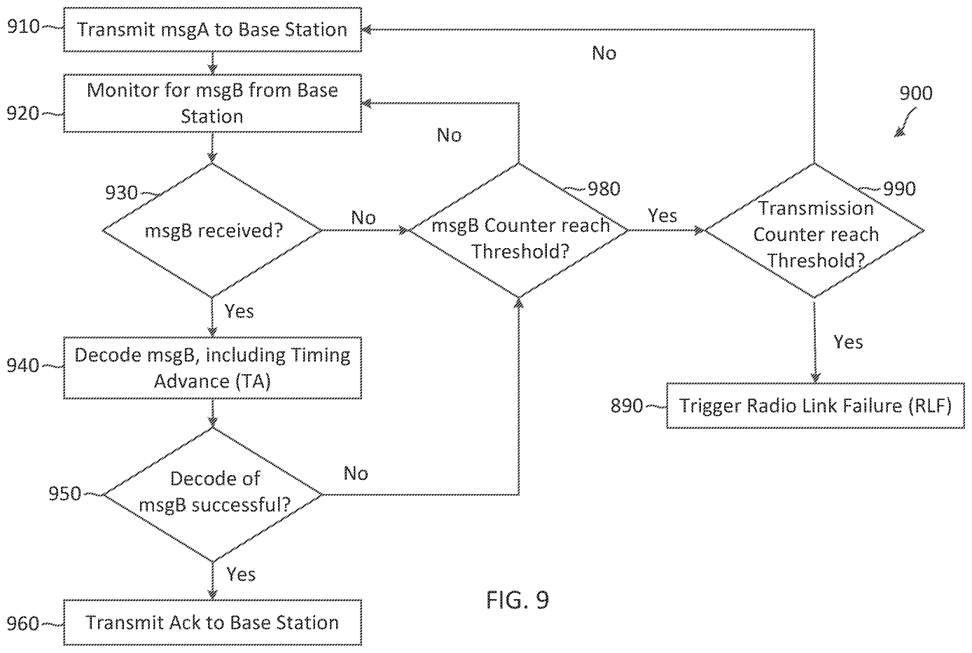

FIG. 9 illustrates a flow diagram of a wireless communication method 900 according to some embodiments of the present disclosure. Aspects of the method 900 can be executed by a wireless communication device, such as the UEs 115, 202, and/or 400 utilizing one or more components, such as the processor 402, the memory 404, the RACH communication and processing module 408, the transceiver 410, the modem 412, the one or more antennas 416, and various combinations thereof, computing device. As illustrated, the method 900 includes a number of enumerated steps, but embodiments of the method 900 may include additional steps before, after, and in between the enumerated steps. For example, in some instances one or more aspects of methods 200, 300, 800, and/or 1200, message structures 600 and/or 650, and/or scheduling/transmission configuration 700 may be implemented as part of method 900. In some embodiments, one or more of the enumerated steps may be omitted or performed in a different order.

Generally speaking, the method 900 includes features similar to method 800 in many respects. For example, steps 910, 920, 930, 940, 950, 960, 990, and 995 are similar to steps 810, 820, 830, 840, 850, 860, 890, and 895, respectively. Accordingly, for sake of brevity, details of those steps will not be repeated here. Please refer to the corresponding descriptions above.

If, at step 930, the RRC-connected UE determines the RACH response message (e.g., msgB) is not received, then the method 900 proceeds to step 980. If, at step 950, the RRC-connected UE determines that the decode of the RACH response message, including the TA command, was unsuccessful, then the method 900 proceeds to step 980.

At step 980, the RRC-connected UE determines whether a counter threshold has been reached. The counter can define the number of times the BS will attempt to transmit the RACH response message (e.g., msgB) to the UE in a given time period. In some instances, the counter is associated with a HARQ process for the RACH response message. The counter can be incremented each time the RRC-connected UE receives the RACH response message (e.g., msgB) and/or an associated control message at step 930. Because the RRC-connected UE may not receive all messages for various reasons, in some instances the RRC-connected UE relies upon an indicator (e.g., downlink assignment index (DAI) or similar index indicator) provided by the BS in a RACH control message (e.g., message 720/740) and/or in the RACH response message (e.g., message 722/742). The indicator can provide the transmission number associated with that particular transmission of the RACH response message. The UE can utilize the received indicator to determine whether the counter threshold has been reached. The threshold or limit for the counter can be set for any suitable number of transmissions, including without limitation between 2 and 100, between 2 and 20, between 2 and 10, 2, 4, 8, 16, 32, 64, etc. The RRC-connected UE may include one or more other counters (e.g., a msgA transmission counter) associated with random access procedures in addition to the counter of step 980. The counter can be reset when the RRC-connected UE successfully completes the random access procedure (e.g., step 960) or triggers a radio link failure (RLF) (e.g., step 995).

If, at step 980, the RRC-connected UE determines that the counter has not reached the threshold, then the method 900 continues to step 920 where the RRC-connected UE monitors for a retransmission of the RACH response message (e.g., msgB) from the BS, as described above.

If, at step 980, the RRC-connected UE determines that the counter has not reached the threshold, then the method 900 continues to step 990 where the RRC-connected UE determines whether a transmission counter threshold has been reached, as described above.

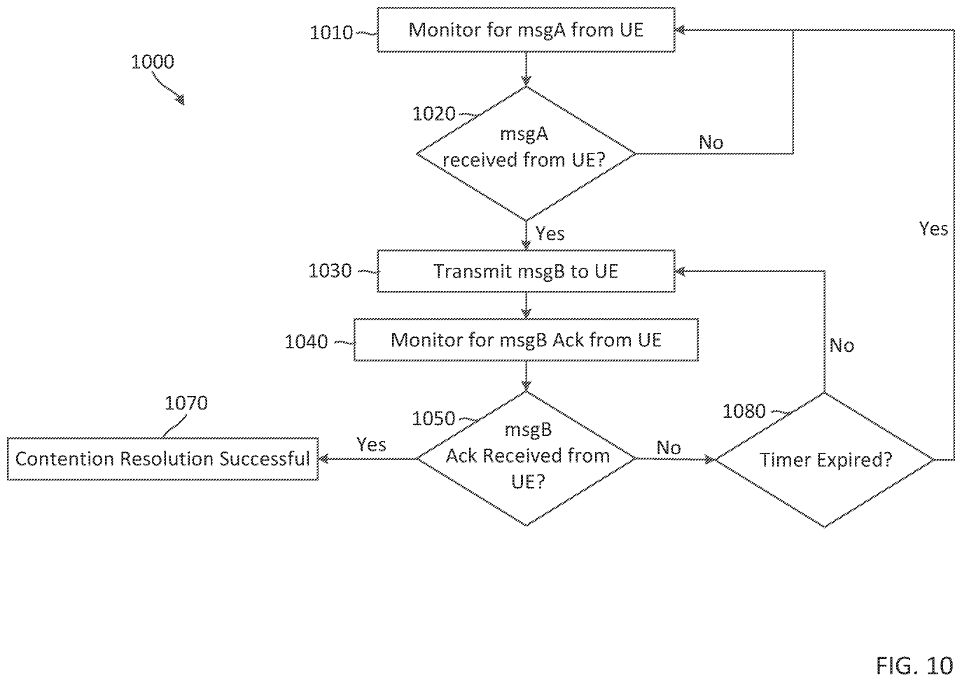

FIG. 10 illustrates a flow diagram of a wireless communication method 1000 according to some embodiments of the present disclosure. Aspects of the method 1000 can be executed by a wireless communication device, such as the BSs 105, 204, and/or 500 utilizing one or more components, such as the processor 502, the memory 504, the RACH communication and processing module 508, the transceiver 510, the modem 512, the one or more antennas 516, and various combinations thereof. As illustrated, the method 1000 includes a number of enumerated steps, but embodiments of the method 1000 may include additional steps before, after, and in between the enumerated steps. For example, in some instances one or more aspects of methods 200, 300, 1100, and/or 1300, message structures 600 and/or 650, and/or scheduling/transmission configuration 700 may be implemented as part of method 1000. In some embodiments, one or more of the enumerated steps may be omitted or performed in a different order.

At step 1010, a BS monitors for a RACH message (e.g., msgA) transmitted by an RRC-connected UE. The RACH message includes an identifier (e.g., C-RNTI) associated with the RRC-connected UE.

At step 1020, the BS determines whether the RACH message (e.g., msgA) has been received. If not, then the method 1000 returns to step 1010. If the RACH message has been received by the BS from the RRC-connected UE, then the method 1000 proceeds to step 1030.

At step 1030, the BS transmits a RACH response message (e.g., msgB) to the RRC-connected UE. In this regard, the BS can send the RRC-connected UE information regarding what time and frequency resources (e.g., time/frequency resources of a PDSCH) are assigned to the RRC-connected UE for the RACH response message. For example, in some instances, as part of step 1020 or a separate step, the BS communicates the assigned time and frequency resources to the RRC-connected UE over a control channel (e.g., PDCCH). The BS can include the identifier (e.g., C-RNTI) received from the RRC-connected UE in the RACH message in the control channel message to indicate to the RRC-connected UE which time and frequency resources are associated with the RACH response message (e.g., msgB) intended for the RRC-connected UE.

At step 1040, a BS monitors for an ACK from the RRC-connected UE related to the RACH response message (e.g., msgB). In this regard, the BS may indicate an ACK resource (e.g., a UCI resource) for the RRC-connected UE to use to transmit the ACK signal. For example, the BS may indicate the ACK resource in a control message and/or the RACH response message at step 1030. In some instances, the BS indicates the ACK resource using an UL grant included with a TA command (e.g., using the message structure of FIG. 6B).

At step 1050, the BS determines whether an ACK from the RRC-connected UE related to the RACH response message (e.g., msgB) has been received. If yes, then the method 1000 proceeds to step 1070 indicating that the random access procedure or contention resolution was successful (e.g., the RRC-connected UE is synchronized with the network). If, at step 1050, the BS determines that an ACK from the RRC-connected UE related to the RACH response message (e.g., msgB) has not been received, then the method 1000 proceeds to step 1080.

At step 1080, the BS determines whether a timer has expired. The timer can define the amount of time the BS will spend attempting to transmit the RACH response message (e.g., msgB) to the RRC-connected UE and/or the amount of time the RRC-connected UE will spend attempting to receive and/or decode the RACH response message (e.g., msgB) from the BS. In some instances, the timer is started upon receipt of the RACH message (e.g., msgA) by the BS in step 1020. The timer can be set for any suitable length of time, including without limitation between 10 ms and 500 ms, between 10 ms and 100 ms, 10 ms, 20 ms, 32 ms, 40 ms, 50 ms, 64 ms, 100 ms, 150 ms, 200 ms, 500 ms, etc. The timer can be canceled or stopped when the RRC-connected UE successfully completes the random access procedure (e.g., step 1070) or the current random access procedure for the RRC-connected UE is terminated (e.g., step 1080 when threshold is reached). The BS may include one or more other timers and/or counters (e.g., HARQ counter) associated with random access procedures in addition to the timer of step 1080.

If, at step 1080, the BS determines that the timer has not expired, then the method 1000 continues to step 1030. At step 1030, the BS retransmits the RACH response message (e.g., msgB) to the RRC-connected UE. In this regard, the retransmission may take the form of HARQ process for the RACH response message. As discussed above, FIG. 7 describes an approach for a HARQ process suitable for the RACH response message (e.g., signals 720 and 722 are associated with the first transmission, while signals 740 and 742 are associated with a retransmission). From step 1030, the method 1000 continues as described above.

If, at step 1080, the BS determines that the timer has expired, then the method 1000 continues to step 1010. In this regard, the BS may terminate the current random access procedure for the RRC-connected UE if the timer has expired.

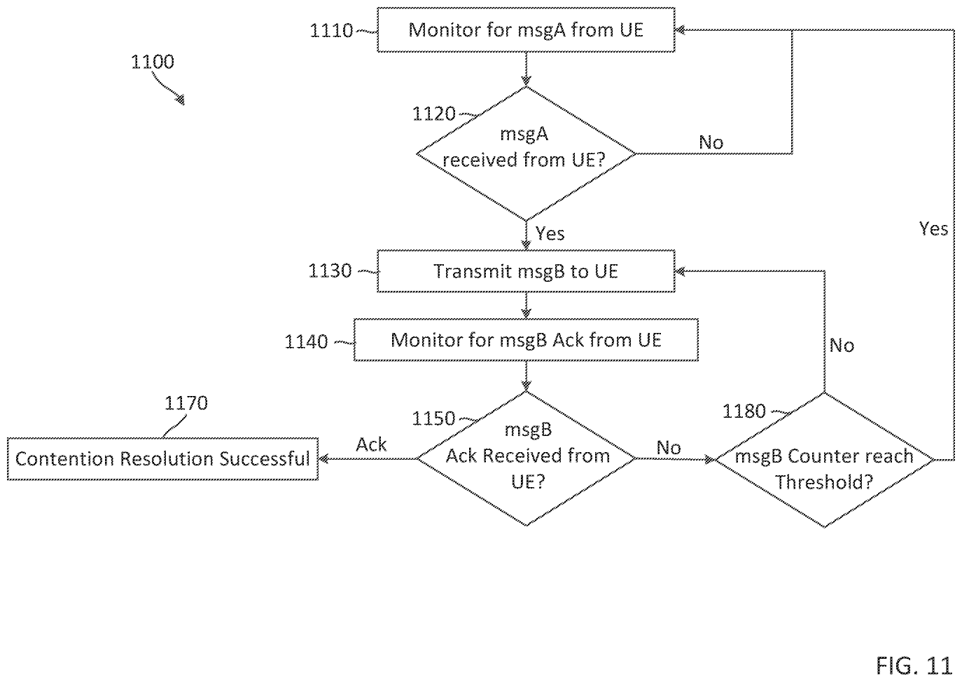

FIG. 11 illustrates a flow diagram of a wireless communication method 1100 according to some embodiments of the present disclosure. Aspects of the method 1100 can be executed by a wireless communication device, such as the BSs 105, 204, and/or 500 utilizing one or more components, such as the processor 502, the memory 504, the RACH communication and processing module 508, the transceiver 510, the modem 512, the one or more antennas 516, and various combinations thereof. As illustrated, the method 1100 includes a number of enumerated steps, but embodiments of the method 1100 may include additional steps before, after, and in between the enumerated steps. For example, in some instances one or more aspects of methods 200, 300, 1000, and/or 1300, message structures 600 and/or 650, and/or scheduling/transmission configuration 700 may be implemented as part of method 1100. In some embodiments, one or more of the enumerated steps may be omitted or performed in a different order.

Generally speaking, the method 1100 includes features similar to method 1000 in many respects. For example, steps 1110, 1120, 1130, 1140, 1150, and 1170 are similar to steps 1010, 1020, 1030, 1040, 1050, and 1070, respectively. Accordingly, for sake of brevity, details of those steps will not be repeated here. Please refer to the corresponding descriptions above.

If, at step 1150, the BS determines that an ACK from the RRC-connected UE related to the RACH response message (e.g., msgB) has not been received, then the method 1100 proceeds to step 1180.

At step 1180, the BS determines whether a counter threshold has been reached. The counter can define the number of times the BS will attempt to transmit the RACH response message (e.g., msgB) to the UE in a given time period. In some instances, the counter is associated with a HARQ process for the RACH response message. The counter can be incremented each time the BS transmits the RACH response message (e.g., msgB) to the RRC-connected UE. In some instances, the BS includes an indicator (e.g., downlink assignment index (DAI) or similar index indicator) in a RACH control message (e.g., message 720/740) and/or in the RACH response message (e.g., message 722/742) sent to the RRC-connected UE. The indicator can provide the transmission number associated with that particular transmission of the RACH response message. The threshold or limit for the counter can be set for any suitable number of transmissions, including without limitation between 2 and 100, between 2 and 20, between 2 and 10, 2, 4, 8, 16, 32, 64, etc. The BS may include one or more other counters and/or timers associated with random access procedures in addition to the counter of step 1180. The counter can be reset when the RRC-connected UE successfully completes the random access procedure (e.g., step 1170) or the current random access procedure for the RRC-connected UE is terminated by the BS (e.g., step 1180 when threshold is reached).

If, at step 1180, the BS determines that the counter has not reached the threshold, then the method 1100 continues to step 1130 where the BS retransmits the RACH response message (e.g., msgB) to the RRC-connected UE, as described above.

If, at step 1180, the BS determines that the counter has reached the threshold, then the method 1100 continues to step 1110. In this regard, the BS may terminate the current random access procedure for the RRC-connected UE if the counter has reached the threshold.

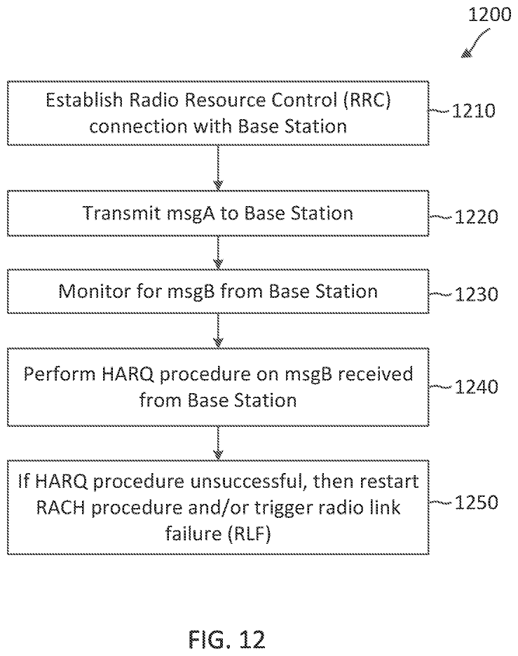

FIG. 12 is a flow diagram of a communication method 1200 according to some embodiments of the present disclosure. Aspects of the method 1200 can be executed by a wireless communication device, such as the UEs 115, 202, and/or 400 utilizing one or more components, such as the processor 402, the memory 404, the RACH communication and processing module 408, the transceiver 410, the modem 412, the one or more antennas 416, and various combinations thereof. As illustrated, the method 1200 includes a number of enumerated steps, but embodiments of the method 1200 may include additional steps before, after, and in between the enumerated steps. For example, in some instances one or more aspects of methods 200, 300, 800, and/or 900, message structures 600 and/or 650, and/or scheduling/transmission configuration 700 may be implemented as part of method 1200. In some embodiments, one or more of the enumerated steps may be omitted or performed in a different order.

At step 1210, the method 1200 includes establishing, by a user equipment (UE) with a base station (BS), a radio resource control (RRC) connection.

At step 1220, the method 1200 includes transmitting, by the RRC-connected UE to the BS, a first random access channel (RACH) message (e.g., msgA).

At step 1230, the method 1200 includes monitoring, by the RRC-connected UE, for a second RACH message (e.g., msgB) from the BS. The second RACH message can include a timing advance (TA) command.

At step 1240, the method 1200 includes performing, by the RRC-connected UE, a hybrid automatic repeat request (HARQ) procedure on the second RACH message.

At step 1250, the method 1200 includes performing, by the RRC-connected UE when the HARQ procedure on the second RACH message fails, at least one of: starting a new RACH procedure; or triggering a radio link failure (RLF).

In some instances, step 1240 includes failing to receive and/or decode, by the RRC-connected UE, the second RACH message. In some instances, the method 1200 further includes determining, by the RRC-connected UE whether a timer has expired. In this regard, the method 1200 can include starting, by the RRC-connected UE, the new RACH procedure if the timer has expired. The method 1200 can also include triggering, by the RRC-connected UE, the RLF if the timer has expired. The method can also include monitoring, by the RRC-connected UE, for a retransmission of the second RACH message from the BS if the timer has not expired.

In some instances, the method 1200 includes determining, by the RRC-connected UE, whether a threshold number of transmissions of the second RACH message has been reached. The method can include starting, by the RRC-connected UE, the new RACH procedure if the threshold number of transmissions of the second RACH message has been reached. The method can also include triggering, by the RRC-connected UE, the RLF if the threshold number of transmissions of the second RACH message has been reached. The method can also include monitoring, by the RRC-connected UE, for a retransmission of the second RACH message from the BS if the threshold number of transmissions of the second RACH message has not been reached.

In some instances, step 1240 includes decoding, by the RRC-connected UE, the second RACH message and transmitting, by the RRC-connected UE to the BS, an acknowledgement (ACK) based on the decoding of the second RACH message being successful. The method 1200 can include resetting, by the RRC-connected UE, at least one of a timer or a counter based on the decoding of the second RACH message being successful. Resetting the timer can include cancelling the timer (e.g., resetting the timer to a start value, but not restarting the timer) in some instances. In other instances, resetting the timer can include restarting the timer (e.g., resetting the timer to a start value and causing the time timer to run).

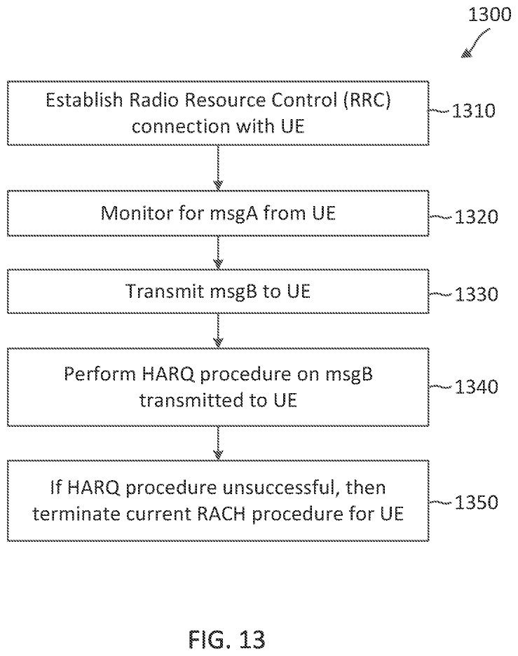

FIG. 13 is a flow diagram of a communication method 1300 according to some embodiments of the present disclosure. Aspects of the method 1300 can be executed by a wireless communication device, such as the BSs 105, 204, and/or 500 utilizing one or more components, such as the processor 502, the memory 504, the RACH communication and processing module 508, the transceiver 510, the modem 512, the one or more antennas 516, and various combinations thereof. As illustrated, the method 1300 includes a number of enumerated steps, but embodiments of the method 1300 may include additional steps before, after, and in between the enumerated steps. For example, in some instances one or more aspects of methods 200, 300, 1000, and/or 1100, message structures 600 and/or 650, and/or scheduling/transmission configuration 700 may be implemented as part of method 1300. In some embodiments, one or more of the enumerated steps may be omitted or performed in a different order.

At step 1310, the method 1300 includes establishing, by a base station (BS) with a user equipment (UE), a radio resource control (RRC) connection.

At step 1320, the method 1300 includes monitoring, by the BS, for a first random access channel (RACH) message (e.g., msgA) from the RRC-connected UE.

At step 1330, the method 1300 includes transmitting, by the BS to the RRC-connected UE, a second RACH message (e.g., msgB) in response to receiving the first RACH message, the second RACH message including a timing advance (TA) command;

At step 1340, the method 1300 includes performing, by the BS, a hybrid automatic repeat request (HARQ) procedure on the second RACH message; and

At step 1350, the method 1300 includes terminating, by the BS, a current RACH procedure for the RRC-connected UE when the HARQ procedure on the second RACH message fails.

In some instances, step 1340 includes failing to receive, by the BS from the RRC-connected UE, an acknowledgement (ACK) associated with the second RACH message. The method 1300 can further include determining, by the BS upon failing to receive the ACK, whether a timer has expired. In some instances, the method 1300 includes terminating, by the BS, the current RACH procedure for the RRC-connected UE if the timer has expired. In some instances, the method 1300 includes retransmitting, by the BS to the RRC-connected UE, the second RACH message if the timer has not expired.

In some instances, the method 1300 includes determining, by the BS upon failing to receive the ACK, whether a threshold number of transmissions of the second RACH message has been reached. In some instances, the method 1300 includes terminating, by the BS, the current RACH procedure for the RRC-connected UE if the threshold number of transmissions of the second RACH message has been reached. In some instances, the method 1300 includes retransmitting, by the BS to the RRC-connected UE, the second RACH message if the threshold number of transmissions of the second RACH message has not been reached.

In some instances, step 1340 includes retransmitting, by the BS to the RRC-connected UE, the second RACH message if the BS does not receive the ACK from the RRC-connected UE. In some instances, step 1340 includes receiving, by the BS from the RRC-connected UE, an acknowledgement (ACK) based on a decoding of the second RACH message by the RRC-connected UE being successful. In this regard, the method 1300 can include resetting, by the BS, at least one of a timer or a counter based on the receipt of the ACK.

In some instances, a user equipment (UE) includes: means for establishing a radio resource control (RRC) connection with a base station (BS); means for transmitting a first random access channel (RACH) message to the BS; means for monitoring for a second RACH message from the BS, the second RACH message including a timing advance (TA) command; means for performing a hybrid automatic repeat request (HARQ) procedure on the second RACH message; and means for performing, when the HARQ procedure on the second RACH message fails, at least one of: starting a new RACH procedure; or triggering a radio link failure (RLF). In some instances, the means for performing the HARQ procedure includes means for decoding the second RACH message.

In some instances, the UE further includes means for determining whether a timer has expired. In some instances, the UE further includes means for starting the new RACH procedure if the timer has expired. In some instances, the UE includes means for triggering the RLF if the timer has expired. In some instances, the means for performing the HARQ procedure includes means for monitoring for a retransmission of the second RACH message from the BS if the timer has not expired.

In some instances, the UE includes means for determining whether a threshold number of transmissions of the second RACH message has been reached. In some instances, the UE further includes means for starting the new RACH procedure if the threshold number of transmissions of the second RACH message has been reached. In some instances, the UE further includes means for triggering the RLF if the threshold number of transmissions of the second RACH message has been reached. In some instances, the means for performing the HARQ procedure includes means for monitoring for a retransmission of the second RACH message from the BS if the threshold number of transmissions of the second RACH message has not been reached.

In some instances, the means for performing the HARQ procedure includes means for decoding the second RACH message. In some instances, the UE further includes means for transmitting an acknowledgement (Ack) to the BS based on the decoding of the second RACH message being successful. In some instances, the UE includes means for resetting at least one of a timer or a counter based on the decoding of the second RACH message being successful.

In some instances, a base station (BS) includes: means for establishing a radio resource control (RRC) connection with a user equipment (UE); means for monitoring for a first random access channel (RACH) message from the RRC-connected UE; means for transmitting a second RACH message to the RRC-connected UE in response to receiving the first RACH message, the second RACH message including a timing advance (TA) command; means for performing a hybrid automatic repeat request (HARQ) procedure on the second RACH message; and means for terminating a current RACH procedure for the RRC-connected UE when the HARQ procedure on the second RACH message fails.

In some instances, the BS includes means for determining whether a timer has expired. In some instances, means for terminating the current RACH procedure for the RRC-connected UE includes means for terminating the current RACH procedure for the RRC-connected UE if the timer has expired. In some instances, the means for performing the HARQ procedure includes means for retransmitting the second RACH message to the RRC-connected UE if the timer has not expired.

In some instances, the BS includes means for determining whether a threshold number of transmissions of the second RACH message has been reached. In some instances, the means for terminating the current RACH procedure for the RRC-connected UE includes means for terminating the current RACH procedure for the RRC-connected UE if the threshold number of transmissions of the second RACH message has been reached. In some instances, the means for performing the HARQ procedure includes means for retransmitting the second RACH message to the RRC-connected UE if the threshold number of transmissions of the second RACH message has not been reached.

In some instances, the means for performing the HARQ procedure includes means for retransmitting the second RACH message to the RRC-connected UE if the BS does not receive an acknowledgment (ACK) (or NACK) from the RRC-connected UE. In some instances, the means for performing the HARQ procedure includes means for receiving an acknowledgement (Ack) from the RRC-connected UE based on a decoding of the second RACH message by the RRC-connected UE being successful. In some instances, the BS includes means for resetting at least one of a timer or a counter based on the receipt of the Ack.

In some instances, a non-transitory computer-readable medium having program code recorded thereon includes: code for causing a user equipment (UE) to establish a radio resource control (RRC) connection with a base station (BS); code for causing the RRC-connected UE to transmit a first random access channel (RACH) message to the BS; code for causing the RRC-connected UE to monitor for a second RACH message from the BS, the second RACH message including a timing advance (TA) command; code for causing the RRC-connected UE to perform a hybrid automatic repeat request (HARQ) procedure on the second RACH message; and code for causing the RRC-connected UE to perform, when the HARQ procedure on the second RACH message fails, at least one of: starting a new RACH procedure; or triggering a radio link failure (RLF). In some instances, the code for causing the RRC-connected UE to perform the HARQ procedure includes code for causing the RRC-connected UE to decode the second RACH message.

In some instances, the non-transitory computer-readable medium further includes code for causing the RRC-connected UE to determine whether a timer has expired. In some instances, the non-transitory computer-readable medium further includes code for causing the RRC-connected UE to start the new RACH procedure if the timer has expired. In some instances, the non-transitory computer-readable medium further includes code for causing the RRC-connected UE to trigger the RLF if the timer has expired. In some instances, the code for causing the RRC-connected UE to perform the HARQ procedure includes: code for causing the RRC-connected UE to monitor for a retransmission of the second RACH message from the BS if the timer has not expired.

In some instances, the non-transitory computer-readable medium further includes code for causing the RRC-connected UE to determine whether a threshold number of transmissions of the second RACH message has been reached. In some instances, the non-transitory computer-readable medium further includes code for causing the RRC-connected UE to start the new RACH procedure if the threshold number of transmissions of the second RACH message has been reached. In some instances, the non-transitory computer-readable medium further includes code for causing the RRC-connected UE to trigger the RLF if the threshold number of transmissions of the second RACH message has been reached. In some instances, the code for causing the RRC-connected UE to perform the HARQ procedure includes code for causing the RRC-connected UE to monitor for a retransmission of the second RACH message from the BS if the threshold number of transmissions of the second RACH message has not been reached.

In some instances, the code for causing the RRC-connected UE to perform the HARQ procedure includes: code for causing the RRC-connected UE to decode the second RACH message, and code for causing the RRC-connected UE to transmit an acknowledgement (Ack) to the BS based on the decoding of the second RACH message being successful. In some instances, the non-transitory computer-readable medium includes code for causing the RRC-connected UE to reset at least one of a timer or a counter based on the decoding of the second RACH message being successful.

In some instances, non-transitory computer-readable medium having program code recorded thereon includes: code for causing a base station (BS) to establish a radio resource control (RRC) connection with a user equipment (UE); code for causing the BS to monitor for a first random access channel (RACH) message from the RRC-connected UE; code for causing the BS to transmit a second RACH message to the RRC-connected UE in response to receiving the first RACH message, the second RACH message including a timing advance (TA) command; code for causing the BS to perform a hybrid automatic repeat request (HARQ) procedure on the second RACH message; and code for causing the BS to terminate a current RACH procedure for the RRC-connected UE when the HARQ procedure on the second RACH message fails.

In some instances, the non-transitory computer-readable medium includes code for causing the BS to determine whether a timer has expired. In some instances, the code for causing the BS to terminate the current RACH procedure for the RRC-connected UE includes code for causing the BS to terminate the current RACH procedure for the RRC-connected UE if the timer has expired. In some instances, the code for causing the BS to perform the HARQ procedure includes code for causing the BS to retransmit the second RACH message to the RRC-connected UE if the timer has not expired.

In some instances, the non-transitory computer-readable medium includes code for causing the BS to determine whether a threshold number of transmissions of the second RACH message has been reached. In some instances, the code for causing the BS to terminate the current RACH procedure for the RRC-connected UE includes code for causing the BS to terminate the current RACH procedure for the RRC-connected UE if the threshold number of transmissions of the second RACH message has been reached. In some instances, the code for causing the BS to perform the HARQ procedure includes code for causing the BS to retransmit the second RACH message to the RRC-connected UE if the threshold number of transmissions of the second RACH message has not been reached.

In some instances, the code for causing the BS to perform the HARQ procedure includes code for causing the BS to retransmit the second RACH message to the RRC-connected UE if the BS does not receive an acknowledgment (ACK) (or NACK) from the RRC-connected UE. In some instances, the code for causing the BS to perform the HARQ procedure includes code for causing the BS to receive an acknowledgement (ACK) from the RRC-connected UE based on a decoding of the second RACH message by the RRC-connected UE being successful. In some instances, the non-transitory computer-readable medium includes code for causing the BS to reset at least one of a timer or a counter based on the receipt of the Ack.

While the disclosed embodiments are described in the context of an RRC-connected UE performing a random access procedure with a BS, the techniques may also be applied to a UE when the UE context is known by the network. In some instances, the techniques may be utilized by UEs in an RRC inactive state (e.g., UE has not data transmissions scheduled) as well as UEs in an RRC connected state.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication, comprising:
transmitting, by user equipment (UE) to a base station (BS), a first random access channel (RACH) message;
monitoring, by the UE, for a second RACH message from the BS, the second RACH message including a timing advance (TA) command;
performing, by the UE, a hybrid automatic repeat request (HARQ) procedure on the second RACH message; and
performing, by the UE when the HARQ procedure on the second RACH message fails, at least one of:
starting a new RACH procedure; or
triggering a radio link failure (RLF).

2. The method of claim 1, further comprising:
establishing, by the UE with the BS, a radio resource control (RRC) connection;
wherein at least the transmitting the first RACH message is performed by the RRC-connected UE.

3. The method of claim 1, further comprising:
determining, by the UE, whether a timer has expired;
wherein the performing, by the UE when the HARQ procedure on the second RACH message fails, includes:
starting, by the UE, the new RACH procedure if the timer has expired.

4. The method of claim 1, further comprising:
determining, by the UE, whether a timer has expired;
wherein the performing, by the UE when the HARQ procedure on the second RACH message fails, includes:
triggering, by the UE, the RLF if the timer has expired.

5. The method of claim 1, further comprising:
determining, by the UE, whether a timer has expired;
wherein the performing the HARQ procedure includes:
monitoring, by the UE, for a retransmission of the second RACH message from the BS if the timer has not expired.

6. The method of claim 1, further comprising:
determining, by the UE, whether a threshold number of transmissions of the second RACH message has been reached;
wherein the performing, by the UE when the HARQ procedure on the second RACH message fails, includes at least one of:
starting, by the UE, the new RACH procedure if the threshold number of transmissions of the second RACH message has been reached; or
triggering, by the UE, the RLF if the threshold number of transmissions of the second RACH message has been reached.

7. The method of claim 1, further comprising:
determining, by the UE, whether a threshold number of transmissions of the second RACH message has been reached;
wherein the performing the HARQ procedure includes:
monitoring, by the UE, for a retransmission of the second RACH message from the BS if the threshold number of transmissions of the second RACH message has not been reached.

8. The method of claim 1, wherein the performing the HARQ procedure includes:
decoding, by the UE, the second RACH message; and
transmitting, by the UE to the BS, an acknowledgement (Ack) based on the decoding of the second RACH message being successful.

9. The method of claim 8, further comprising:
resetting, by the UE, at least one of a timer or a counter based on the decoding of the second RACH message being successful.

10. The method of claim 1, further comprising:
starting, by the UE, a timer in a first symbol following the transmitting the first RACH message.

11. A method of wireless communication, comprising:
monitoring, by a base station (BS) with a user equipment (UE), for a first random access channel (RACH) message from the UE;
transmitting, by the BS to the UE, a second RACH message in response to receiving the first RACH message, the second RACH message including a timing advance (TA) command;
performing, by the BS, a hybrid automatic repeat request (HARQ) procedure on the second RACH message; and
terminating, by the BS, a current RACH procedure for the UE when the HARQ procedure on the second RACH message fails.

12. The method of claim 11, further comprising:
establishing, by the BS with the UE, a radio resource control (RRC) connection.

13. The method of claim 11, further comprising:
determining, by the BS, whether a timer has expired;
wherein the terminating the current RACH procedure for the UE includes:
terminating, by the BS, the current RACH procedure for the UE if the timer has expired.

14. The method of claim 11, further comprising:
determining, by the BS, whether a timer has expired;
wherein the performing the HARQ procedure includes:
retransmitting, by the BS to the UE, the second RACH message if the timer has not expired.

15. The method of claim 11, further comprising:
determining, by the BS, whether a threshold number of transmissions of the second RACH message has been reached;
wherein the terminating the current RACH procedure for the UE includes:
terminating, by the BS, the current RACH procedure for the UE if the threshold number of transmissions of the second RACH message has been reached.

16. The method of claim 11, further comprising:
determining, by the BS, whether a threshold number of transmissions of the second RACH message has been reached;
wherein the performing the HARQ procedure includes:
retransmitting, by the BS to the UE, the second RACH message if the threshold number of transmissions of the second RACH message has not been reached.

17. The method of claim 11, wherein the performing the HARQ procedure includes:
retransmitting, by the BS to the UE, the second RACH message if the BS does not receive an acknowledgment (Ack) or a Nack from the UE.

18. The method of claim 11, wherein the performing the HARQ procedure includes:
receiving, by the BS from the UE, an acknowledgement (Ack) associated with the second RACH message; and
the method further comprises:
resetting, by the BS, at least one of a timer or a counter based on the receipt of the Ack.

19. A user equipment, comprising:
a transceiver configured to:
transmit a first random access channel (RACH) message to the BS; and
monitor for a second RACH message from the BS, the second RACH message including a timing advance (TA) command; and
a processor in communication with the transceiver, the processor configured to:
perform a hybrid automatic repeat request (HARQ) procedure on the second RACH message; and
perform, when the HARQ procedure on the second RACH message fails, at least one of:
start a new RACH procedure; or
trigger a radio link failure (RLF).

20. The user equipment of claim 19, wherein the transceiver is further configured to:
establish a radio resource control (RRC) connection with a base station (BS).

21. The user equipment of claim 19, wherein the processor is further configured to:
decode the second RACH message.

22. The user equipment of claim 21, wherein the processor is further configured to:
determine whether a timer has expired, and
start the new RACH procedure or trigger the RLF if the timer has expired.

23. The user equipment of claim 21, wherein the transceiver is further configured to monitor for a retransmission of the second RACH message from the BS if the timer has not expired.

24. The user equipment of claim 20, wherein the processor is further configured to:
determine whether a threshold number of transmissions of the second RACH message has been reached; and
start the new RACH procedure or trigger the RLF if the threshold number of transmissions of the second RACH message has been reached; and

25. The user equipment of claim 24, wherein the transceiver is further configured to monitor for a retransmission of the second RACH message from the BS if the threshold number of transmissions of the second RACH message has not been reached.

26. The user equipment of claim 24, wherein:
the processor is further configured to:
decode the second RACH message; and
reset at least one of a timer or a counter based on the decoding of the second RACH message being successful; and
the transceiver is further configured to transmit, to the BS, an acknowledgement (Ack) based on the decoding of the second RACH message being successful.

27. A base station, comprising:
a transceiver configured to:
monitor for a first random access channel (RACH) message from the UE; and
transmit a second RACH message to the UE in response to receiving the first RACH message, the second RACH message including a timing advance (TA) command; and
a processor in communication with the transceiver, the processor configured to:
perform a hybrid automatic repeat request (HARQ) procedure on the second RACH message; and
terminate a current RACH procedure for the UE when the HARQ procedure on the second RACH message fails.

28. The base station of claim 26, wherein the processor is further configured to:
determine whether a timer has expired; and
at least one of:
terminate the current RACH procedure for the UE if the timer has expired; or
retransmit, to the UE, the second RACH message if the timer has not expired.

29. The base station of claim 26, wherein the processor is further configured to:
determine whether a threshold number of transmissions of the second RACH message has been reached; and
at least one of:
terminate the current RACH procedure for the UE if the threshold number of transmissions of the second RACH message has been reached; or
retransmit the second RACH message to the UE if the threshold number of transmissions of the second RACH message has not been reached.

30. The base station of claim 26, wherein:
the transceiver is further configured to:
receive an acknowledgement (Ack) from the UE based on a decoding of the second RACH message by the UE being successful; and
the processor is further configured to:
reset at least one of a timer or a counter based on the receipt of the Ack.
